(19) United States
(12) Patent Application Publication
(10) Pub. No.: US 2005/0273487 A1
(43) Pub. Date: Dec. 8, 2005

(54) Automatic multimodal enabling of existing web content

(75) Inventors: Amir Mayblum, Kadima (IL); Michael Cogan, Tel Aviv (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/902,063

(22) Filed: Jul. 30, 2004

Related U.S. Application Data
(60) Provisional application No. 60/576,810, filed on Jun. 4, 2004.

(51) Int. Cl. G06F 15/16

(52) U.S. Cl. 709/202

(57) ABSTRACT

A system and a method for enabling existing web content to become multimodal. The system has a browser providing a user with markup language web pages. In addition, the system has an agent for creating dynamic grammar for a web page loaded by the browser. The dynamic grammar has one or more commands and one or more corresponding labels. A command is a markup language tag or a markup object used to navigate the browser and a label is content text that corresponds to the command. The system also includes a speech recognition engine, which receives user voice input and compares the received input to the labels in the dynamic grammar. When the speech recognition engine finds a match, the speech recognition engine transmits the corresponding command to the agent and the agent navigates the browser using the command.

### CROSS-REFERENCE TO RELATED APPLICATIONS

This application claims the benefit of U.S. Provisional Patent Application No. 60/576,810 titled “Automatic Multimodal Enabling of Existing Web Content” filed on Jun. 4, 2004, the disclosure of which is incorporated by reference in its entirety.

### BACKGROUND OF THE INVENTION

1. Field of the Invention

A system and a method consistent with the present invention broadly relates to providing a user interface for obtaining information from the web. More particularly, the present invention is consistent with providing a voice enabled graphic user interface.

2. Description of the Related Art

Explosive growth in the world-wide web in the past fifteen years, has made it one of the most popular sources for obtaining and sharing information. The Web is a collection of data pages and is made up of three standards. First standard, the Uniform Resource Locator (URL), specifies how each page of information is given a unique address (this unique address defines the location of the page). Second standard, Hyper Text Transfer Protocol (HTTP), specifies how the browser and the server send information to each other, and the third standard, Hyper Text Markup Language (HTML), is a method of authoring the information so it can be displayed on a variety of devices.

With the growth of the Web, however, other authoring methods became widely available, e.g., WML (Wireless Markup Language) or XML (Extensible Markup Language). Presently, these markup methods are used to author static web page content such as a company's web site and dynamic content, which is web content generated on demand. A simple example is a personal greeting that pops up when a regular customer returns to a particular web site. A more elaborate scheme might provide a customer with a set of recommendations based on the past interactions with the site. The dynamic web content typically appears as click-able links and is widely used for news web sites, archives, flight schedules etc., for example see FIG. 1, which shows a BBC web page as it appears on a Personal Digital Assistant (PDA) device.

Users can obtain information from the World Wide Web using a program called a browser which retrieves pieces of information (web pages), from the web servers (web sites), and displays them on the screen. The user can then follow a hyperlink on each page to other documents or even send information back to the server. This type of interaction is commonly known as user interface.

The most common types of user interfaces are graphic user interface (GUI) and voice user interface (VUI), although other types are being designed. For example, Semacode (http://semacode.org/), originated by Simon Woodside and Ming-Yee Iu, designed a system that uses barcodes as URL tags for an HTML browser. In the Semacode's system, a user uses a camera phone to convert the barcodes into URLs. Thereby, a bar code can be placed on a physical object, the user walking by would use the camera phone to read the bar code obtaining an URL tag where additional information about the object can be found.

In addition, some conventional techniques attempt to convert a standard GUI into a VUI. For example, U.S. Pat. No. 6,085,161 to MacKenty et al., incorporated herein by referece, teaches representing HTML documents audibly via VUI. Similarly, U.S. Pat. No. 6,587,822 to Brown et al., incorporated herein by reference, teaches another VUI called interactive voice response application, which allows users to communicate with the server via speech without expensive specialized hardware. Likewise, U.S. Pat. No. 6,115,686 to Chung et al., incorporated by reference, teaches converting HTML documents to speech.

To facilitate user interaction with a computer, however, it may be beneficial to provide the user with more than one mode of communication. New approaches attempting to combine the two interfaces are being designed, creating a MultiModal interface. Multimodality allows the user to provide input to a system by mouse, keyboard, stylus or voice, and it provides feedback to the user by either graphics or voice (pre-recorded prompts or synthesized speech). This approach provides the user with the flexibility to choose his preferred mode of interaction according to the environment, the device capabilities, and his preferences. For example, a car driver can browse through his voice-mail using voice commands, without taking his hands off the wheel. A person can type SMS (Short Messages Service) messages during a meeting or dictate them while driving.

Multimodal applications enable users to input commands either by mouse, stylus, keyboard or vocally. Output is provided either graphically or by synthesized/prerecorded speech. Multimodality may become the user interface of the future, providing an adaptable user experience, which changes according to the situation, the device capabilities, and the user preferences. Multimodality is especially attractive for the mobile industry, the disabled people and other cellular users.

Until recently, cellular user experience, as any other telephony system, was built on top of the voice call. Recent changes in the market have introduced a new data-based experience to the cellular world that is growing rapidly. While new data applications require higher usage of the hands, pointing out information with the stylus, typing and navigating with the five way joystick and text-based user interface (TUI)—modem life enforces the usage of cellular phones and new data services in a busy environment where user's hands are busy and are not available for an application operation and control. In addition, buttons and other controls on the cellular device tend to be of minuscule size and present a challenge to most users.

Furthermore, as technology evolves, people tend to expect more of the handset applications. They want to be able to use more of their senses when dealing with their phones and not just their palms. Recent development of handsets technology, mainly an open handset architecture, standardization and more powerful CPU, enables the users to fulfill all these targets with a single framework development. The Multimodal framework will enable the users to operate their devices using four senses instead of two. Talk and listen as well as visual graphics display and touching will ensure a rich user experience.

A user will be able to operate his device in a preferred way regardless of the choices he made earlier. For example, the user will be able to click in a list box to open a message and than have the message read to him or her and forwarded to a friend, all accomplished by voice. This will also ensure that the user can have his hands free for driving and other activities and will be able to operate his data session in the same environment he does his handset activities today.

Web browsing and browser-based applications challenge traditional HTML and other markup content by requiring it to be updated with speech tags that specify the available speech commands (a.k.a. the available grammar). Emerging standards such as Speech Application Language Tags (SALT from Microsoft™) and XHTML+voice (X+V from IBM® and Opera™) formalize the way to write browser-based applications that take advantage of Multimodal technology. These competing standards provide a way to write both graphic user interface as well as vocal commands available to the user.

Translating HTML pages into SALT or X+V, however, requires major rewrite of the existing web content. These rewrites are costly and no tools are available for this task. Major content providers on the Internet do not have a clear incentive to make this investment, especially for the dynamic web content, which may change daily or even hourly.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

It is an aspect of the present invention to provide a method consistent with enabling multimodality for existing web content without any re-writing of an existing page. The method includes loading a web page by a browser and displaying it to a user. The browser is in a user device. In addition, the method includes generating the grammar for the loaded web page by a software agent. The method further includes recognizing one or more user inputs and navigating the browser based on the recognized user input. When one user input is voice input, the method further includes recognizing the voice input based on the created grammar and navigating the browser based on the recognized user input and the created grammar.

It is another aspect of the present invention to provide a system consistent with enabling an existing web content to become multimodal. The system has a browser which provides a user with markup language web pages. The system further includes an agent, which creates dynamic grammar for a web page loaded by the browser. The dynamic grammar has at least one command and at least one corresponding label.

Moreover, the system further includes a speech recognition engine, which receives user voice input, and compares the received input with the dynamically generated grammar. When the speech recognition engine finds a match, the speech recognition engine transmits the corresponding command to the agent, and the agent navigates the browser using this command. A command can be a markup language tag or an object and a label may be a content text that corresponds to the command.

### BRIEF DESCRIPTION OF THE DRAWINGS

The above objects and other advantages of the present invention will become more apparent by describing in detail the illustrative, non-limiting embodiments thereof with reference to the accompanying drawings, in which:

FIG. 1 is an example of a conventional web page as it appears on a PDA device.

FIG. 2 is a block of the system for enabling the web content with multimodality in accordance with a first illustrative, non-limiting embodiment.

FIG. 3 is a flow chart of upgrading existing web content with multimodality in accordance with the first embodiment.

FIG. 4 is a block diagram of the agent in accordance with a second illustrative, non-limiting embodiment.

FIGS. 5A and B are flow charts of upgrading existing web content with multimodality in accordance with the second embodiment.

### DETAILED DESCRIPTION OF THE ILLUSTRATIVE NON-LIMITING EMBODIMENTS

The present invention will now be described in detail by describing illustrative, non-limiting embodiments thereof with reference to the accompanying drawings. In the drawings, the same reference marks denote the same elements. The invention may, however, be embodied in many different forms and should not be construed as being limited to the illustrative embodiments set forth herein. Rather, the embodiments are provided so that this disclosure will be thorough and complete, and will fully convey the concept of the invention to those skilled in the art.

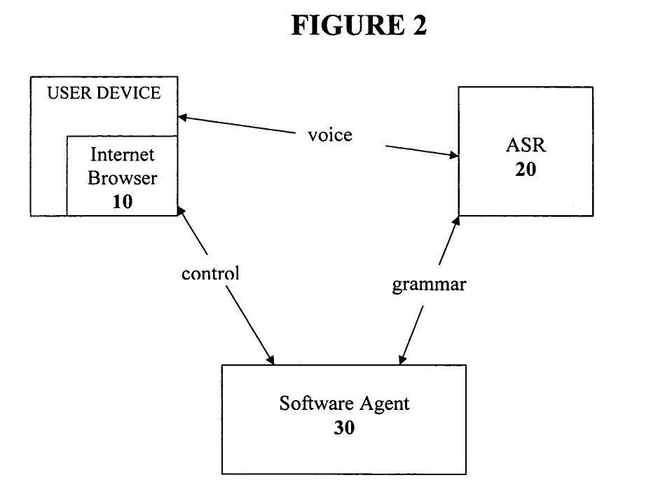

In this illustrative, non-limiting embodiment, as shown in FIG. 2, a system is provided with an Internet browser 10 in a user device, a software agent 20 and an Automated Speech Recognition Engine (ASR) 30. The Internet Browser 10 is used by the user to view the Internet content. The Internet Browser 10 can be a Mosaic, Netscape Navigator, Mozilla, Opera, Lynx, W3, Internet Explorer or WAP browser. Other Internet browsers are within the scope of the invention. The agent 20 analyzes the web content and creates grammar for the ASR 30. The web page may be encoded using HTML, WAP, XML, or any other type of markup language. The ASR 30 uses the grammar created by the agent 20 to analyze user vocal input received from the user device. Thereby, the user may navigate the web content using voice commands in addition to mouse, keyboard or stylus.

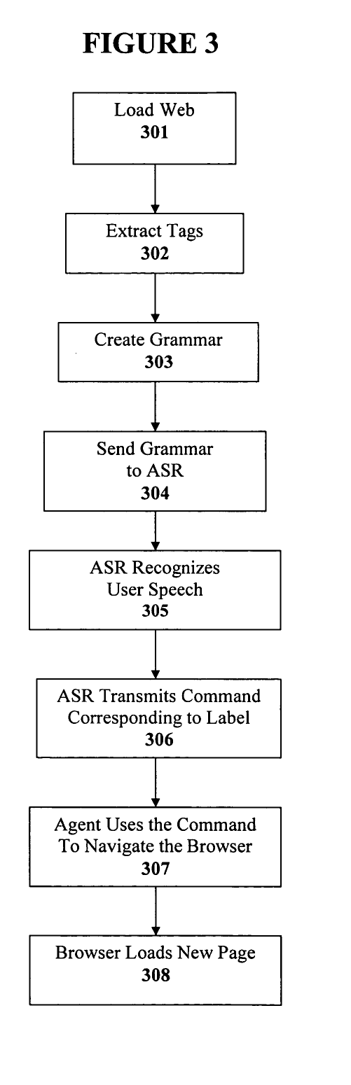

In this illustrative, non-limiting embodiment, the process of converting HTML web content into multimodal web content is described. In step 301, as shown in FIG. 3, the Internet Browser 10 loads a new HTML web page. The agent 20 acquires and analyzes the loaded HTML page. In particular, markup language source documents include tags and content text. The HTML tags are enclosed between “<” and “>”. There are two types of HTML tags, namely, start tags and end tags. A start tag starts with “<” and an end tag starts with “</”. Thus, for example, an HTML statement “<a href=URL>” content text </a> is interpreted as follows: “<a href=URL>” is a start tag and “</a>” is an end tag. The above example means that if the user clicks on the content text, the browser will navigate to a corresponding URL. Some of the other tags may define menus, buttons, check-boxes etc. So for example, when the user says the label of a button, that button is clicked; or when the user says the label of a check box it is automatically checked or unchecked. The label is the content text. In other words, if the user speaks the label, the corresponding command should be executed.

The agent 20 parses the loaded page and extracts the HTML tags that can be used as commands at step 302. In this exemplary embodiment, the agent 20 looks into the HTML file and analyzes each tag. If the tag is “<a href=“/2004/WORLD/economy.html”>” Market surges </a>, for example, then at step 303, the agent 20 creates the following grammar rule: if the user says “Market surges”, the browser should be navigated to /2004/WORLD/economy.html. Next, at step 304, the newly constructed grammar is sent to the ASR 30.

The ASR 30 loads this grammar and uses this grammar to analyze user speech. In particular, at step 305, the ASR 30 recognizes user speech to correspond to a label. Then, at step 306, the ASR 30 transmits the command corresponding to the recognized label to the agent 20. The agent 20 uses the command to navigate the Browser 10, at step 307. For example, the Browser 10 may load a new web page. Therefore, the grammar for the web site is created at run time providing multimodality for any type of web page without changing the actual source code of the HTML web page.

As explained above, the same principle holds with fields as well as other HTML objects. Those can be identified by their tag names and a dynamic grammar representation can be created at runtime. The agent 20 can create grammar for web application, logon screens and so on. For example, the agent 20 can create grammar for an HTML based mail services such as hotmail or yahoo.

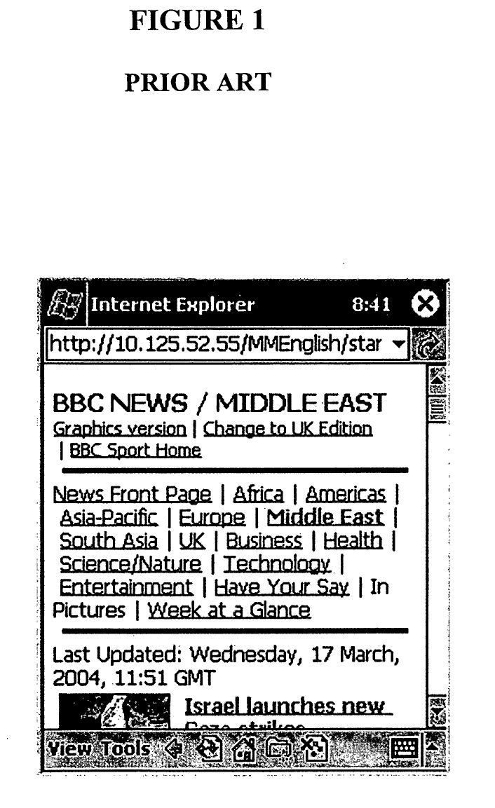

The Multimodal system can then use this grammar and provide the user with the ability to use the speech mode in addition to the graphic user interface on non-multimodal enabled web content. For example, all of the web content shown in FIG. 1 may be speech enabled. The user may simply speak “Change to UK Edition” and the system will reload the web page with UK edition. Similarly, the user may simply speak the title or a hyperlink on the flashing banner and he will be redirected to a different web page.

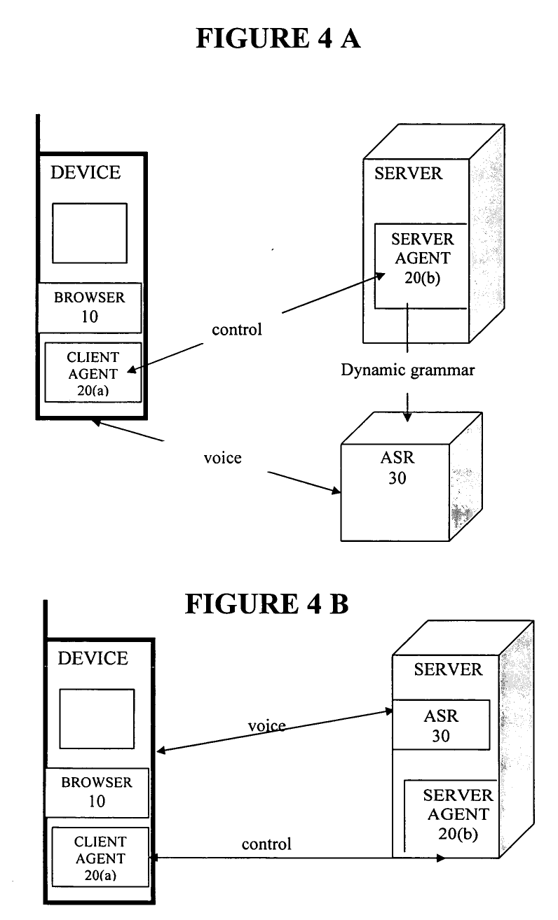

The agent 20 is dividable into a client agent 20(a) and a server agent 20(b), for implementation preferences, and in order to meet device memory and CPU constrains, see FIGS. 4A and 4B. For example, this may be useful for a cellular network. In this second exemplary embodiment, the Browser 10 may communicate with the client agent 20(a) and the client agent communicates with the server agent 20(b). The server agent 20(b) communicates with the ASR 30, see FIG. 4A. The ASR 30 is a different logical component. It may reside in the same physical unit with the server agent 20(b), for example, in a server as shown in FIG. 4B. Alternatively, the ASR 30 may reside in a different physical unit from the server agent 20(b) as shown in FIG. 4A. The client agent 20(a) resides on the client device with the Browser 10, and a server agent 20(b) resides on a server in the network, see FIG. 4A. For example, the client device, on which the client agent 20(a) resides, may be a Palm device, a Smartphone, a PocketPC, Symbian series 60, GPRS, WiFi or Bluetooth enabled device. The client device as well as the server agent obtain web contents over an IP network from a web server or an application specific server depending on the web contents.

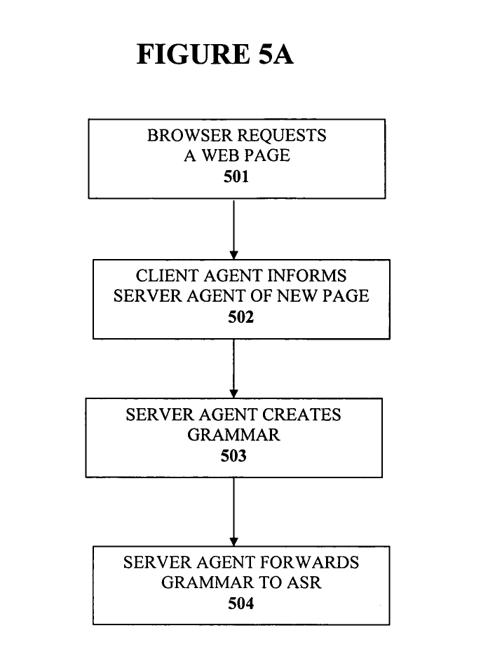

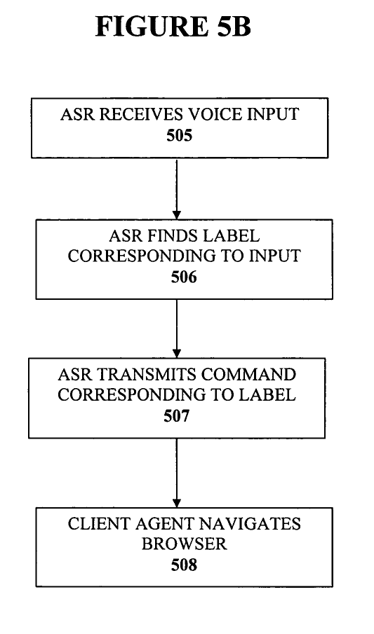

Enabling an existing HTML web page to become multimodal in accordance with the second exemplary embodiment is shown in FIGS. 5A and 5B. FIG. 5A illustrates enabling a web page to become multimodal and FIG. 5B illustrates how the user uses the multimodal enabled web page. As illustrated in FIG. 5A, when the Browser 10 requests a web page at step 501, the client agent 20(a) informs the server agent 20(b) about the change at step 502. In particular, the client agent 20(a) sends the URL to server agent 20(b). The server agent 20(b) then loads this same web page that was loaded by the browser 10, analyzes it as described above, and creates the appropriate grammar at step 503. The grammar is sent to the ASR engine 30 at step 504.

Once the grammar for the web page is created, a sound icon may appear on the display of the user device to indicate that the existing webpage is voice enabled. The web page can be loaded by the browser 10 before the grammar is generated. Once the grammar is generated, however, a sound icon indicate voice enablement, may appear on the display of the user device. Alternatively, the grammar may be generated prior to the display of the requested web page. This web page may also have a sound icon to indicate that the web page is voice enabled.

Voice from the device is delivered to the ASR engine 30, in any means known, and the speech recognition takes place at step 505 as illustrated in FIG. 5B. For example, the voice from the device may be delivered to the ASR engine 30 using DSR or AMR speech codex. The ASR engine 30 recognizes user speech and searches through the created grammar to find a label corresponding to the user voice input at step 506. If the ASR engine 30 finds a label corresponding to the user voice input, the ASR engine 30 then transmits a command which corresponds to this label. This command is returned to the client agent 20(a) at step 507, and the client agent 20(a) navigates the browser 10 to the requested destination at step 508 as illustrated in FIG. 5B.

These exemplary embodiments are consistent with maintaining the web pages unchanged. No re-write of the existing web content is required. Moreover, in these embodiments, the standard web page is converted into a multimodal page without any support from the page “owner”. The grammar is created at runtime. Thereby, dynamic web content becomes multimodal on the fly.

These exemplary agents provide the results in a clear user interface, as the available commands are always visible to the user as part of the GUI. Also, unlike some of the prior art approaches, which convert the GUI into the VUI, in these exemplary embodiment, the user may still conventionally interact with a GUI using a mouse, keyboard or a stylus. The approach to multimodality in these illustrative embodiments requires no major investment and no-rewrites of the existing content. As a result, this approach is consistent with being cheap and easy.

The above and other features of the invention including various novel method steps and a system of the various elements have been particularly described with reference to the accompanying drawings and pointed out in the claims. It will be understood that the particular process and construction of parts embodying the invention is shown by way of illustration only and not as a limitation of the invention. The principles and features of this invention may be employed in varied and numerous embodiments without departing from the spirit and scope of the invention as defined by the appended claims.

1. A method of providing multimodality for an existing web content, comprising:
loading a web page by a browser in a user device;
generating grammar for the loaded web page by a software agent;
displaying the loaded web page to a user;
recognizing at least one user input; and
navigating the browser based on the recognized user input,
wherein when the at least one user input is voice input, recognizing the voice input based on the generated grammar and navigating the browser based on the recognized user input and the generated grammar.

2. The method according to claim 1, wherein when the recognized user input is received via mouse, stylus or keyboard, navigating the browser using graphic user interface.

3. The method according to claim 2, further comprising parsing the loaded web page for commands, and generating the grammar based on the extracted commands and corresponding labels.

4. The method according to claim 3, wherein when the user voice input is the label, the extracted command is transmitted to the browser, and based on the command the browser is navigated.

5. The method according to claim 4, wherein the extracted command is a markup language tag.

6. The method according to claim 5, wherein the loaded web page is written in a markup language.

7. The method according to claim 6, wherein the loaded web page is written in at least one of a hyper text markup language, a wireless markup language and an extensible markup language.

8. The method according to claim 2, wherein the wireless device is a mobile phone.

9. The method according to claim 2, wherein the wireless device is one of a pocketPC, a Bluetooth enabled device, a WiFi enabled device or a GPRS terminal.

10. The method according to claim 2, wherein for each loaded web page new grammar is generated.

11. The method according to claim 2, wherein the grammar is generated at run time when the browser requests a new web page, the grammar is generated for recognizing the user voice input and wherein the web page has dynamic content.

12. The method according to claim 2, wherein said software agent comprises a client agent and a server agent.

13. The method according to claim 12, wherein the client agent informs the server agent of the loading web page and wherein the server agent generates the grammar.

14. The method according to claim 13, wherein the client agent sends an address of the web page being loaded to the server agent.

15. The method according to claim 14, wherein the server agent parses the loaded web page for commands, and generates the grammar based on the extracted commands, and wherein the server agent transmits the generated grammar to a speech recognition engine.

16. The method according to claim 15, wherein the speech recognition engine recognizes the user voice input based on the grammar from the server agent, and transmits a command based on the recognized input to the browser, and the browser is navigated based on the command.

17. The method according to claim 2, wherein said loaded web page is a page from a web application.

18. The method according to claim 2, wherein said loaded web page is a dynamic web page and said grammar is generated when the web page is being loaded.

19. The method according to claim 2, wherein said loaded web page is a dynamic web page displayed to a user, and wherein the grammar is generated after the web page is loaded.

20. The method according to claim 19, wherein when the grammar is generated, an indicating means indicates that the web page is voice enabled.

21. A system for enabling existing web content to become multimodal, comprising:
a browser providing a user with a markup language web pages;
an agent creating dynamic grammar for a web page loaded by the browser, the dynamic grammar comprises at least one command and at least one corresponding label; and
a speech recognition engine receiving user voice input and comparing the received input to the at least one label in the dynamically generated grammar,
wherein when the speech recognition engine finds a match, the speech recognition engine transmits the corresponding command to the agent and wherein the agent navigates the browser using the command.

22. The system according to claim 21, wherein the user is enabled to navigate the browser via a mouse, a keyboard, a stylus and voice.

23. The system according to claim 22, wherein the browser is in a wireless device and wherein for each loaded web page new grammar is generated.

24. The system according to claim 22, wherein the extracted command is a markup language tag.

25. The system according to claim 22, wherein the loaded web page is written in a text markup language.

26. The system according to claim 25, wherein the loaded web page is written in at least one of a hyper text markup language, a wireless markup language and an extensible markup language.

27. The system according to claim 22, wherein the wireless device is a mobile phone.

28. The system according to claim 22, wherein the wireless device is one of a pocketPC, a Bluetooth enabled device, a WiFi enabled device and a GPRS terminal.

29. The system according to claim 22, wherein the grammar is dynamic grammar generated at run time and wherein the web page has dynamic contents.

30. The system according to claim 29, wherein the dynamic contents is time sensitive information.

31. The system according to claim 30, wherein the time sensitive information comprises news stories, weather information, financial news, and sports scores.

32. The system according to claim 29, wherein the dynamic grammar is generated at runtime for an email application.

33. The system according to claim 22, wherein the agent is a software agent comprising a client agent in the wireless device and a server agent.

34. The system according to claim 33, wherein the client agent informs the server agent when the web page is loaded by the browser, and in response the server agent requests the web page from a web server or an application specific server via an IP network, and when the page is received by the server agent, the server agent parses the page creating the dynamic grammar.

35. The system according to claim 34, wherein the server agent passes the dynamic grammar to the speech recognition engine.

36. The system according to claim 34, wherein the server agent and the speech recognition engine is in the same server, and wherein the client agent and the browser are in the same wireless device remote from the server.

37. The system according to claim 34, wherein the speech recognition engine transmits a command that corresponds to the label spoken by the user and recognized by the speech recognition engine, the command is transmitted to the client agent and wherein the client agent navigates the browser using the command.

38. The system according to claim 34, wherein the speech recognition engine receives the user voice input from the wireless device, and the dynamic grammar from the service agent located in a remote server.

39. The system according to claim 38, wherein the web page comprises at least one of: an HTML page, a WML page, and an XML page.

40. The system according to claim 21, wherein the web page is an HTML encrypted page.
